(19) United States
(12) Patent Application Publication
(10) Pub. No.: US 2009/0169923 A1
(43) Pub. Date: Jul. 2, 2009

(54) SUBSTRATE PROCESSING USING THE VAPOR SUPPLYING APPARATUS

(75) Inventors: Hisashi Yamamoto, Fujiyoshida-shi (JP); Masahiro Shibamoto, Yokohama-shi (JP)

Correspondence Address: FITZPATRICK CELLA HARPER & SCINTO, 30 ROCKEFELLER PLAZA, NEW YORK, NY, 10112, US

(73) Assignees: CANON ANELVA CORPORATION, Kawasaki-shi (JP); CANON ANELVA TECHNIX CORPORATION, Kawasaki-shi (JP)

(21) Appl. No.: 12/342,293

(22) Filed: Dec. 23, 2008

(30) Foreign Application Priority Data
Dec. 27, 2007 (JP) 2007-336759

(51) Int. Cl. C23C 18/00; G11B 5/84; B05C 11/10; B32B 33/00

(52) U.S. Cl. 428/800; 118/666; 427/8; 427/58; 428/411.1; 428/688

(57) ABSTRACT

A vapor supplying apparatus comprises a holding unit for holding a liquid or solid substance; cooling means for cooling the holding unit; detection means for detecting the temperature of the holding unit; and a control means for controlling said cooling means based on the temperature detected by the detection means. The temperature of the holding unit is adjusted by using the cooling means under the control of the control means, thereby to control vaporization or sublimation of the liquid or solid substance in supplying a vapor of the substance. Means for measuring the pressure of the vapor vaporized or sublimated from the liquid or the solid substance is provided under the atmosphere in which the water supplying apparatus is placed, and the control means controls the temperature of the holding unit so that the pressure of the vapor becomes a predetermined value based on the measured pressure.

### CROSS-REFERENCES TO RELATED APPLICATIONS

This application claims the benefit of priority from Japanese Patent Application No. 2007-336759 filed Dec. 27, 2007, the entire contents of which is incorporated herein by reference.

### BACKGROUND OF THE INVENTION

1. Field of the Invention

The present invention relates to a vapor supply apparatus for supplying a vapor and a substrate processing apparatus and a substrate processing method using the same, a method of manufacturing an electronic device, and an electronic device manufactured by using the method of manufacturing an electronic device.

2. Related Background Art

Many of the recent electronic devices use oxide films or films containing oxide. For example, a tunneling magnetoresistance device mounted on a magnetic head of a magnetroresistive random access memory (MRAM) and a hard disc drive (HDD) uses an oxide (for example, aluminum oxide and magnesia oxide) of mere several atom layers in thickness between two magnetic films. In the magnetic recording medium of HDD, a CoCrPt magnetic film containing an oxide (for example, SiO₂) is a main stream for the vertical magnetic recording system. Further, a resistance random access memory RAM (RRAM) which is currently being aggressively developed also uses a metal alloy oxide or an oxide thin film as a recording film.

The HDD magnetic head of the next generation needs to attain lower resistance of the element, and hence, a current perpendicular to plane giant magnetroresistive (CPP-GMR) film which operates by letting the current flow vertically to the film surface becomes a leading candidate.

In this element, to obtain desired magnetoresistance characteristics, a nonmagnetic space layer existing between the magnetic layers needs to be made into a granular structure composed of the oxide and the metal. However, in the current film formation technology, a fluctuation of the film structure is large, and this causes a problem of the durability of the element.

The film formation of the oxide or the film containing the oxide is devised such that these electronic devices operate with high reliability. For example, according to U.S. Pat. No. 7,033,685, for forming a Co based granular magnetic film, an Ar sputtering gas is mixed with minute amounts of oxygen or nitrogen, thereby to perform reactive sputtering. By so doing, in the vicinity of the Co based magnetic crystal particles, an oxide layer is formed, so that magnetic mutual interaction between the magnetic crystal particles is blocked, and medium noise is reduced, and it is considered that the magnetic recording medium having a high signal-to-noise ratio can be fabricated at low cost.

Further, in U.S. Pat. No. 5,302,493, to improve the characteristics of a magnetooptical recording medium, a method of introducing the oxygen, the carbon dioxide, the vapor gas, and the like effective for the reactive oxidation process into a vacuum device during the film formation is used. As a result, the film surface becomes uniform, and the output is also improved.

Further, another electronic device requiring precise substrate processing includes a magnetic random access memory (hereinafter, referred to as MRAM) having a tunneling magnetoresistance film (hereinafter, referred to as TMR film). FIG. 9 is a schematic diagram of a typical structure of the electronic device. Such a structure is, for example, described in Japanese Patent Application Laid-Open No. 2005-101441. A multilayer film is formed in order of a seed layer 52, an under layer 53, an anti-ferromagnetic layer 54, a magnetic pinned layer 55, a barrier layer 56, a magnetic free layer 57, and cap layer 58 from a substrate 51 side.

In this device, the direction of magnetic moment of the magnetic pinned layer 55 is pinned by a exchange coupling with the anti-ferromagnetic layer 54. On the other hand, the direction of magnetic moment of the magnetic free layer 57 can be changed by an external signal. When the directions of the magnetic moments of the magnetic pinned layer 55 and the magnetic free layer 57 are matched, the current is made to easily flow through the barrier layer 56 existing between those two layers, and in other words, the electric resistance is small. On the other hand, when the directions of the magnetic moments of the magnetic pinned layer 55 and the magnetic free layer 57 are unmatched, and are oriented to an opposite direction each other, the current is made to hardly flow through the barrier layer 56 existing between these two layers, in other words, the electric resistance is large. The MRAM having the TMR film memorizes information according to the change of the resistance. Further, the HDD magnetic head also uses the TMR film, and is put on the market.

In the manufacturing process of the MRAM having the TMR film, the film quality of the barrier layer 56 largely affects the final performance. While the barrier layer 56 includes aluminum oxide (Al₂O₃), magnesium oxide (MgO), and the like, these oxide films need to satisfy a stoichiometric ratio to achieve higher performance.

Patent References: U.S. Pat. No. 7,033,685
U.S. Pat. No. 5,302,493
JP Laid-Open 2005-101441

However, for example, there has been a problem that the control of the substrate processing such as oxidation of the barrier layer is not easy.

As means for solving this problem, the following means are considered. Here, a description will be made only by focusing on oxidation processing.
1) Oxygen is directly supplied by a mass flow controller.
2) Atmosphere is leaked, and oxidation is made by oxygen and water contained therein.
3) Water is supplied by a liquid mass flow controller.

In the process 1), since oxygen is a strong oxidizing agent, only slightly much amount of oxygen causes an excessive oxidization, but if few, a state of oxygen deficiency occurs. That is, there is a problem that the control is very difficult.

In the process 2), since the supplied mount of the water serving also as the oxidizing agent fluctuates by the moisture fluctuating of the atmosphere, this leads to a problem that the control is very difficult similarly to the process 1).

In the process 3), if condensed water remains inside the processing chamber, it is difficult to remove this water from the processing chamber, and this also leads to a problem that the process other than the oxidation process is harmed.

### SUMMARY OF THE INVENTION

The present inventors have intensively carried out studies in order to solve these problems 1) to 3), and as a result, have found that a liquid or solid vapor can be supplied for a predetermined amount accurately and in a good reproducibility by controlling the temperature of the holding unit which holds the liquid or solid vapor to control the vapor pressure, thereby conceiving the present invention.

Vapor supplying apparatus according to the present invention, comprises a holding unit for holding a liquid or solid substance, cooling means for cooling the holding unit, detection means for detecting the temperature of the holding unit, and control means for controlling the cooling means based on the temperature detected by the detection means,

wherein the temperature of the holding unit is adjusted by the cooling means under the control of control means, thereby to control vaporization or sublimation of the liquid or solid substance in supplying a vapor of the substance.

A method of manufacturing an electronic device, according to the present invention, by processing a substrate provided with the electronic device in the substrate processing chamber in cooperation with the above mentioned vapor supplying apparatus comprises steps of measuring the pressure of the vapor inside the substrate processing chamber, and processing the substrate while controlling the temperature of said holding unit by the control means so that the pressure of the vapor becomes a predetermined value based on the measured pressure.

A method of manufacturing an electronic device, according to another aspect of the present invention by processing a substrate provided with an electronic device in a substrate processing chamber in cooperation with the above mentioned vapor supplying apparatus comprises steps of for a time other than the vapor supplying time, lowering the temperature of the holding unit than the temperature at the vapor supplying time by the cooling means and the control means to liquefy or solidify the vapor for holding the liquid or solid substance in the holding unit, and for the vapor supplying time, elevating the temperature of the holding unit by the cooling means and the control means to vaporaize or sublimate the held liquid or solid substance for supplying the vapor of the substrate, to perform the processing of the substrate.

A substrate processing method, according to the present invention, for processing a substrate in a substrate processing chamber in cooperation with the above mentioned vapor supplying apparatus comprises the steps of measuring the pressure of the vapor inside the substrate processing chamber, and controlling the temperature of the holding unit by the control means so that the pressure of the vapor becomes a predetermined value based on the measured pressure for the processing of the substrate.

A substrate processing method, according to another aspect of the present invention, for processing a substrate in a substrate processing chamber in cooperation with the above mentioned vapor supplying apparatus comprises steps of for a time other than the vapor supplying time, lowering temperature of the holding unit than the temperature at the vapor supplying time by the cooling means and the control means to liquefy or solidify the vapor to hold the liquid or solid substance in the holding unit, and

for the vapor supplying time, elevating the temperature of the holding unit by the cooling means and the control means to vaporize or sublimate the held liquid or for supplying the vapor of the substrate.

In the present patent application, “vaporization” means that a liquid changes into a gas (vapor) or a solid substance changes into a gas (vapor) through a liquid. Sublimation means that a solid substance changes into a gas (vapor). Further, liquescence means that a gas (vapor) changes into a liquid. “Solidification” means that a gas (vapor) changes into a solid substance or the liquid changes into a solid substance.

By the present invention, the vapor can be controlled and supplied. As a result, for example, the processing of the substrate requiring the supply of the controlled vapor can be achieved.

### BRIEF DESCRIPTION OF THE DRAWINGS

FIG. 1 is a schematic sectional view of a substrate processing apparatus of one embodiment of the present invention.

FIG. 2 is a perspective view of a part of a vapor supplying apparatus.

FIG. 3 is a graph showing an equilibrium vapor pressure characteristic of the water.

FIG. 4 is a view showing a layer structure of an in-plane magnetic recording medium.

FIG. 5 is a characteristic view showing a relationship between Hc (holding capacity) and a gas flow rate in case where oxygen (O₂), atmosphere (air), and vapor (H₂O) are introduced.

FIG. 6 is a characteristic view showing a relationship of S* with the gas flow rate of introduced atmosphereand vapor.

FIG. 7 is a view for explaining S* (S star).

FIG. 8 is a sectional block diagram of a film forming chamber in a multilayer film forming apparatus of the magnetic recording medium.

FIG. 9 is a sectional view showing a structure of a tunneling magnetoresistance element.

FIG. 10 is a flowchart showing a control flow of the vapor pressure before starting the film formation or during the film formation.

FIG. 11 is a flowchart showing a control flow of the vapor pressure whose temperature is lowered except for the film formation time requiring the water supply.

### DESCRIPTION OF THE PREFERRED EMBODIMENTS

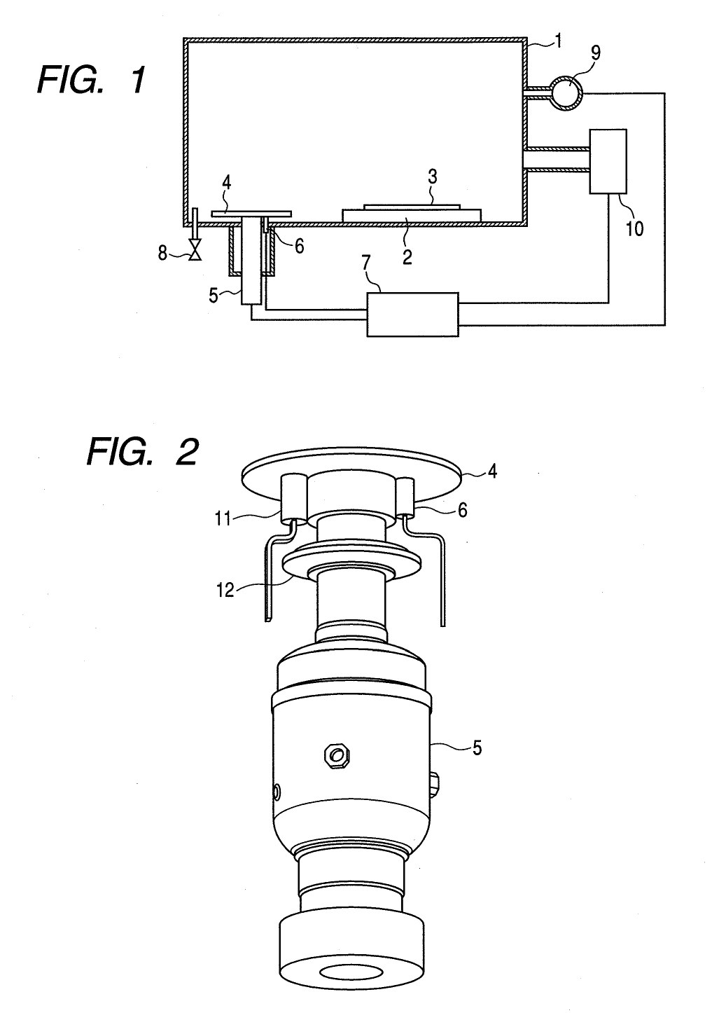

An embodiment of the present invention will be described below by using FIGS. 1 and 2. FIG. 1 shows an embodiment of a substrate processing apparatus including a vapor supplying apparatus, and FIG. 2 is a perspective view of a part of the vapor supplying apparatus.

The vapor supplying apparatus holds the water in a liquid or a solid state, and comprises a water supplying unit 4 for evaporating and supplying the water according to need; a cooler 5 for controlling the temperature of the water supplying unit 4; a temperature measurement means 6 for measuring the temperature of the water supplying unit 4 or the cooler 5; a heating means (heater) 11 used when the water supplying unit 4 is desired to be heated; a vacuum flange 12; and a cooler control unit 7 (not shown in FIG. 2) for controlling the cooler 5.

The vapor supplying apparatus sometimes includes a means for measuring the pressure of the vapor of the vacuum gauge 9, a mass spectrometer 10, and the like. The heating means is attached when the speed of raising temperature is desired to be increased, and is provided according to need.

As shown in FIG. 1, a processed material 3 is loaded on a holder 2 where the process material 3 is positioned inside the vacuum chamber 1, and the oxide film is formed on the processed material 3 by sputtering using an oxide target (not shown). In this case, the water supplying unit 4 whose temperature can be optionally lowered and controlled by the cooler 5 is installed inside the vacuum chamber 1. The water supplying unit 4 or the cooler 5 is loaded with the temperature measurement means 6, and this temperature signal is configured to be processed by a cooler controller 7 and capable of temperature measurement. As the temperature measurement means 6, for example, a temperature measurement resistance element such as a thermocouple, a platinum temperature measurement resistance element (Pt-100), and the like, and a silicon diode sensor can be used. The water supplying unit 4 serves as a holding unit for holding the water as liquid or solid, the cooler 5 as a cooling means, the temperature measurement means 6 as a detection means, the cooler control unit 7 as a control means, and the vacuum chamber 1 as a substrate processing chamber.

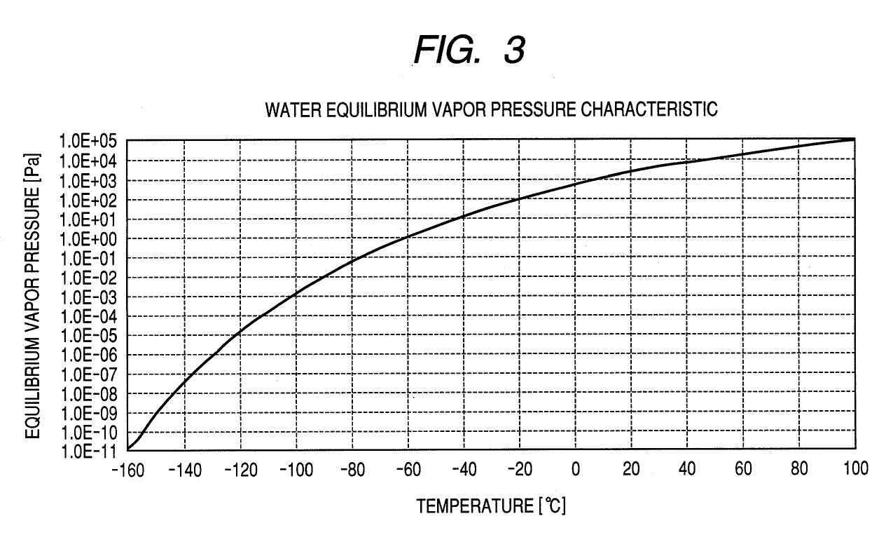

In the water supplying unit 4, sufficient water is condensed in advance. For example, when the processed material 3 is supplied with the water at a partial pressure of 10⁻³ Pa (pascal), since the temperature which becomes a vapor pressure of 10⁻³ Pa is approximately −100° C. according to an equilibrium vapor pressure characteristic (FIG. 3), an operation control of the cooler 5 is performed by the cooler controller 7 based on the signal of the temperature detection means 6 so that the water supplying unit 4 becomes −100° C. Similarly, when the water supply of 10⁻² Pa is required, since the temperature which becomes an equilibrium a vapor pressure of 10⁻² Pa is approximately −90° C., the operation control is performed at −90° C. In FIG. 3, for example, 1.0E+05 shows 1.0×10⁵ Pa, and 1.0E−11 shows 1.0×10⁻¹¹ Pa.

When further strict control of the water supply amount is required, it can be controlled by feeding back the output of the vacuum gauge 9 loaded in the vacuum chamber 1 to the cooler controller 7, and by controlling the temperature of the cooler 5 so that the pressure becomes constant, thereby performing the required control. In the low vacuum zone of 10⁻³ Pa or more, since a ratio of the residual water pressure of the total pressure is extremely large, even when the feedback is made at the total pressure, an approximately precise control can be performed. In other words, the pressure of the vapor is approximately equal to the total pressure.

In case where further strict control is required, the partial-pressure vacuum gauge 9 or the mass spectrometer 10 is installed in the vacuum chamber 1, and the output thereof is fed back to the cooler controller 7 so as to be made constant. By so doing, the control can be performed such that if the pressure of the vapor determined by the output of the vacuum gauge or the mass spectrometer 10 is lower than the pressure (predetermined pressure value) to be targeted, the temperature of the water supplying unit 4 is elevated, and if the pressure of the vapor is higher than the pressure to be targeted, the temperature of the water supplying unit 4 is lowered.

The vacuum gauge, the partial-pressure vacuum gauge, and the mass spectrometer serve as the means for measuring the pressure of the vapor which is vaporized or sublimated from the liquid or the solid substance of the atmosphere in which the vapor supplying apparatus is placed.

Further, except for the film formation time requiring the water supply (except for the vapor supplying time), the cooler 5 is operated to become sufficiently low temperature. By so doing, the water supplying unit 4 is sufficiently cooled to reduce the supply of the vapor, thereby it becomes possible to reduce the adverse effect to another film and another processed material requiring no water or another adjacent vacuum chamber.

In the case of the short substrate processing time such as sputtering and the like, since the temperature control of the water supplying unit that uses the cooler and the heating means (heater) takes time to some extent, it is sometimes difficult to control a pressure change of the vapor by the temperature control of the water supplying unit. In this case, the temperature control of the water supplying unit may be performed at the non-sputtering time to keep the temperature in an equilibrium state, and that temperature may be maintained at the sputtering time.

Here, as the type of the cooler 5, a sterling cooler is desirable, which can be operated and controlled from the low temperature to the room temperature by controlling an input voltage. However, a Gifford-McMahon (GM) cooler, a solvaycycle cooler, or a pulse pipe cooler, and the like can be also used. In this case, however, an unillustrated heating means is required to be loaded to perform the temperature control. Due to the depletion of the water in the water supplying unit, no matter how much the temperature is elevated, there are often the cases where the water pressure is not increased. It is desirable to have determined a controllable temperature range of the cooler 5 in advance to protect the cooler 5 or to prevent the temperature of the water supplying unit 4 from increasing excessively. For example, the temperature control range of the cooler 5 is restricted to 0C or less, and when the cooler temperature reaches 0° C., an alarm can be issued.

With respect to the water amount kept accumulated in the water supplying unit 4, for example, assuming that an exhaust velocity of an unillustrated main exhaust pump is 500 L/S, a water supplying amount necessary for making the pressure of the vacuum chamber 1 as 10⁻³ Pa is 0.5 PaL/S, and this becomes 0.3 sccm if converted into a gas flow amount. Assuming that the water is supplied for two consecutive weeks, it amounts to 0.3×60 (minutes)×24 (hours)×14 (days)=6048 cc (gas), which is 0.27 mol, and the water of an approximately 5 g may be condensed in advance by using a leak valve 8 and the like. That is, as a water holding unit that keeps the water condensed, it is sufficient to be compact in shape and in thermal capacity. A part of the supplied vapor can be also supplied through this leak valve 8. By the usage in this manner, the number of stopping times of the operations of the apparatus for water replenishment can be reduced. The water supplying unit is preferably installed at an outlet port of the leak valve 8 in order to efficiently introduce the water from the leak valve.

In the present embodiment, while the vapor supplying apparatus is provided in the vacuum chamber, it may be provided along the way of the piping. However, since there is a possibility that the water may be condensed along the way of the piping, the vapor supplying apparatus is favorably provided in the vacuum chamber. An umbrella (shield) may be provided on the water supplying unit 4 of the vapor supplying apparatus. By providing the umbrella, for example, in the case where plasma generation is performed inside the vacuum chamber 1, the water supplying unit can be prevented from being directly exposed to the plasma, excessively heated and as a result excessively supplied with the water.

Further, in the present embodiment, as the oxidizing agent, the vapor was used. Since the water, as compared with oxygen, is moderate oxidization agent, there is further advantage that the controllability is improved. The present embodiment is described taking oxidation processing as an example for processing of a substrate. However, the technical idea of the present invention is that the substrate processing gas is held in a liquid or solid state in the cooled holding unit, and the temperature of the holding unit is controlled by the cooling means, thereby to control vaporization or sublimation of the liquid or solid substance and supply the gas (vapor), and the material of the gas is not particularly limited.

As the gas (vapor) to be supplied, oxygen, carbon dioxide, and steam which are effective for reactive reaction process can be cited, and carbon dioxide can be supplied by sublimating dry ice.

As the substrate processing apparatus, the vapor supplying apparatus of the present embodiment can be used also for an apparatus other than a thin film forming apparatus, for example, a dry etching apparatus.

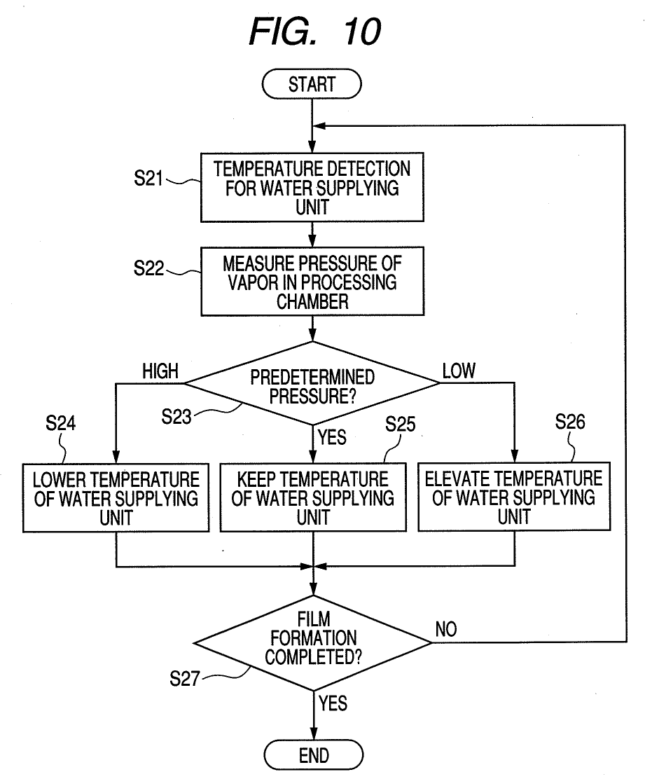

A control flow of the vapor pressure before starting the film formation or during the film formation will be described using FIG. 10. Here, a case of controlling the temperature of the water supplying unit will be described by detecting the temperature of the water supplying unit and measuring the pressure of the vapor inside the substrate processing chamber (vacuum chamber). As shown in FIG. 10, before starting the film formation or during the film formation, the temperature of the water supplying unit 4 is detected (step S21). As described above, by using the vacuum gauge 9, the mass spectrometer 10 and the like, the pressure of the vapor inside the substrate processing chamber (vacuum chamber) is measured (step S22). As a result of the measurement, the cooler control unit 7 determines whether or not the pressure of the vapor is a predetermined pressure (step S23), and if it exceeds the predetermined pressure, the temperature of the water supplying unit 4 is lowered. If it is a predetermined pressure, the temperature of the water supplying unit 4 is maintained, and if it is lower than the predetermined pressure, the temperature of the water supplying unit 4 is elevated (steps S24, S25, and S26). Next, determination is made whether or not the film formation is completed (step S27), and if not completed, the procedure returns to step S21, and if completed, the substrate processing flow is completed. The detection of the temperature of the water supplying unit 4 may be performed at the same time as the measurement of the pressure of the vapor or after the measurement of the pressure of the vapor. In the case where the detection of the temperature of the water supplying unit 4 is performed after the measure of the pressure of the vapor, if the film formation is not completed at step S27, the procedure will return to the operation of the measurement of the pressure of the vapor.

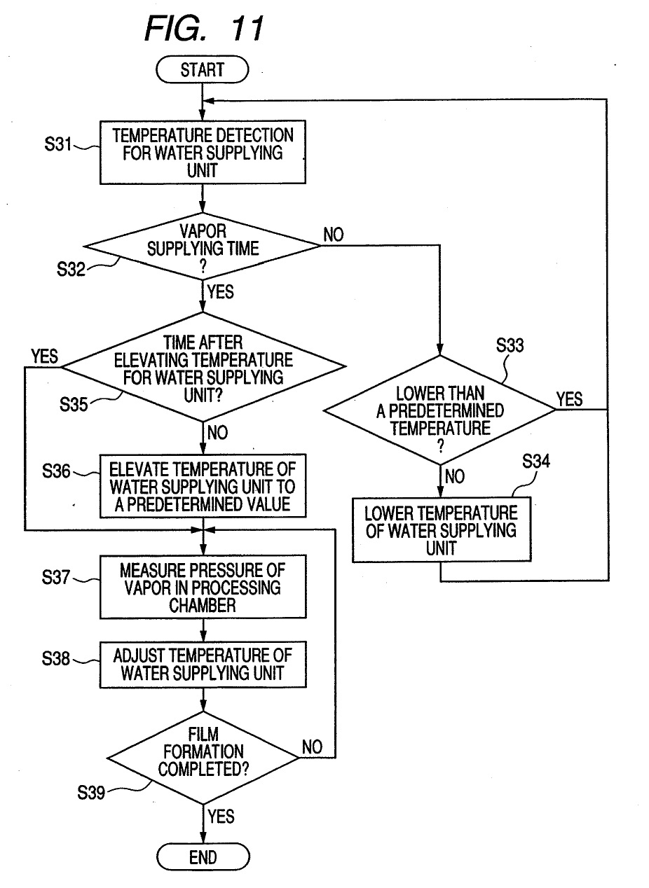

Further, a flow of the control of the pressure of the vapor which lowers the temperature at other than the time of the film formation which requires the water supply will be described. As shown in FIG. 11, first, the temperature of the water supplying unit 4 is detected (step S31). Next, determination is made whether or not it is a vapor supplying time (film formation time) (step S32). If it is not the vapor supplying time (other than the film formation time), determination is made whether or not the temperature of the water supplying unit 4 is lower than the predetermined temperature at the film formation time (step S33), and if lower, the procedure returns to step S31, and if higher, returns to step S31 after the temperature of the water supplying unit 4 is lowered. In this manner, the processing of reducing the supply of the vapor is performed except for the film formation time. If it is the supplying time of the vapor, determination is made whether or not the temperature is elevated from the temperature except for the film formation time to the temperature (predetermined temperature) at the film formation time (step S35). If the temperature is elevated to the predetermined temperature, the pressure of the vapor inside the substrate processing chamber (vacuum chamber) is measured (step S37). If the temperature is not elevated, the temperature of the water supplying unit 4 is elevated to the predetermined temperature, and after that, the procedures proceeds to step S37. Based on the measurement result of the pressure, as described in FIG. 10, the temperature adjustment of the water supplying unit 4 is performed (step S38). Determination is then made whether or not the film formation is completed (step S39), and if not completed, the procedure returns to step S37, and if completed, the substrate processing flow is completed. After the substrate processing flow is completed, the procedure may return to step S31.

The substrate processing apparatus of the present embodiment described above can be used for the fabrication of nonmagnetic spacer layers containing the oxides (tunneling barrier layer (for example, aluminum oxide and magnesium oxide)) of several atom layers formed between two magnetic films in the tunneling magnetoresistance film mounted on the magnetic head of the MRAM and the hard disc drive (HDD). This can be also applied to a giant magnetoresistance element having a giant magnetoresistance film which operates by letting the current flow to the film surface in a vertical direction. Of course, it is also effectively applied to a giant magnetic element using a giant magnetoresistance effect that lets the current flow in parallel with the film surface.

Further, it can be used for the fabrication of a CoCrPt magnetic film containing the oxide (for example SiO₂) which is used in the magnetic recording medium of the HDD.

Further, it can be used for the fabrication of the film or the oxide thin film containing the oxide and metal particles having vertical magnetic anisotropy used as the recording film of a variable resistance type RAM (RRAM). In the film formation of a Co based granular magnetic film, when an Ar sputtering gas is mixed with minute amounts of vapor and reactive sputtering is performed, the substrate processing apparatus of the present embodiment can be used. It can be used for the fabrication of the film magnetized in the direction parallel to the substrate of the magnetic recording medium.

Further, when the vapor gas effective for the reactive oxidizing process is artificially introduced into the vacuum apparatus during the film formation of a magnetooptical recording medium, the substrate processing apparatus of the present embodiment can be used.

Further, for the fabrication of the tunneling magnetoresistance film (hereinafter, referred to as TMR film) of a magnetic random access memory (hereinafter, referred to as MRAM), the substrate processing apparatus of the present embodiment can be used.

As an example of the electronic device of the present invention, a case of fabricating the magnetic recording medium by using the thin film forming apparatus of the present embodiment will be described.

First, the characteristic in the case of forming the oxide layer by using the vapor in the magnetic recording medium will be described in the comparison with a case of introducing the vapor, the oxygen, and the air.

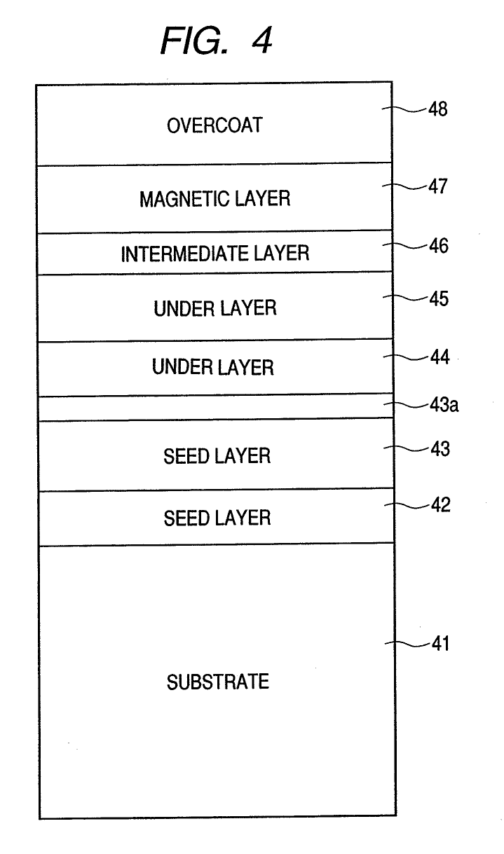

In FIG. 4 is described a layer structure of the magnetic recording medium. In FIG. 4, reference numeral 42 denotes a first seed layer of 3 nm in thickness composed of Ta formed on a substrate 41, numeral 43 a second seed layer of 30 nm in thickness composed of NiP, numeral 44 a first under layer of 12 nm in thickness composed of Cr, numeral 45 a second under layer of 15 nm in thickness composed of CrMo, numeral 46 an intermediate layer of 2 nm in thickness composed of CoCr, numeral 47 a magnetic layer of 20 nm in thickness composed of CoCrPtB, and numeral 48 an overcoat of 5 nm in thickness composed of C. The first seed layer 42 to the magnetic layer 47 are film-formed by sputtering using a multilayer film forming apparatus to be described later, and the overcoat 48 is film-formed by CVD. A film-forming pressure is taken as 6 mTorr for the first seed layer 42 to the magnetic layer 47, and it is taken as 20 mTorr for the overcoat 48. The applying power is 200 W, 2000 W, 500 W, 700W, 250 W, 900 W, and 1000 W, respectively for the first seed layer 42, the second seed layer 43, the first under layer 44, the second under layer 45, the intermediate layer 46, the magnetic layer 47, and the overcoat 48.

In the film formation of the second seed layer 43, after the film formation is performed by sputtering, the oxide material is introduced, and thereby the terminal part of the second seed layer 43 is oxidized to form an oxide layer 43a.

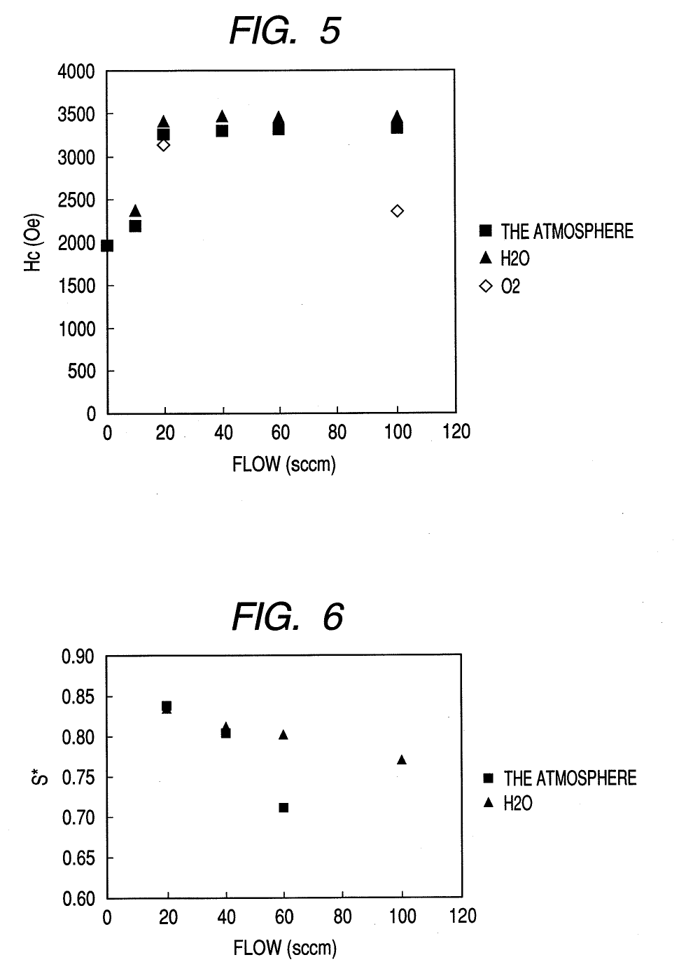

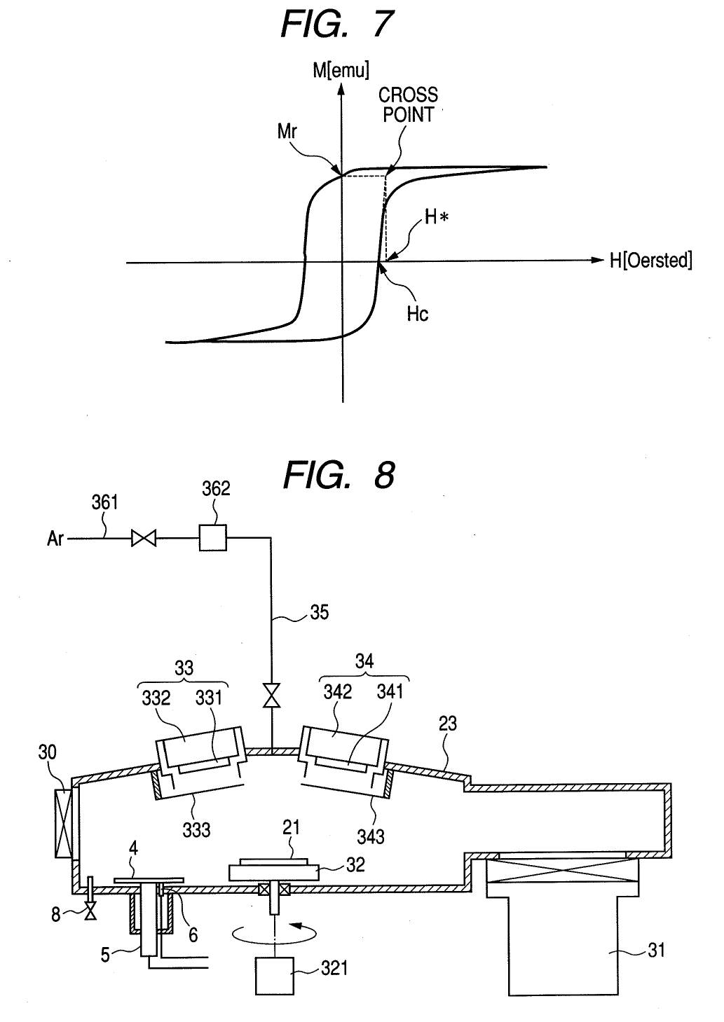

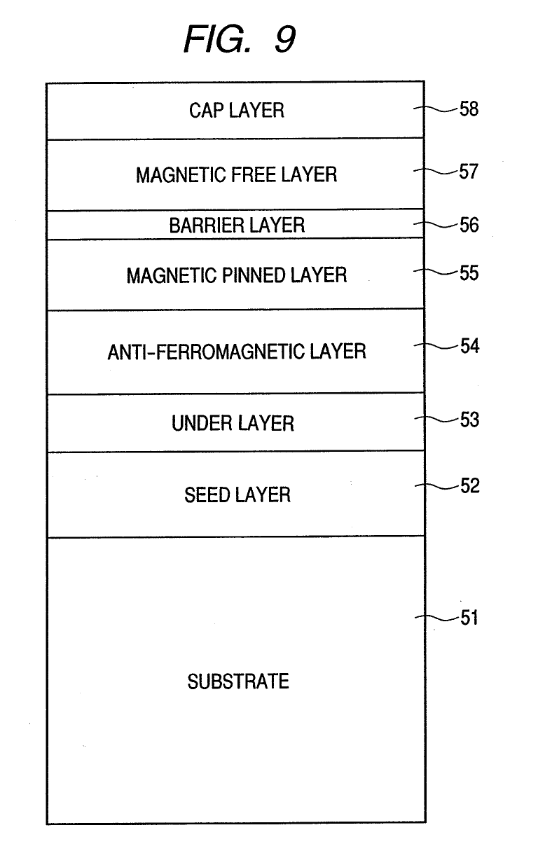

A characteristic view showing a relationship between Hc (holding capacity) and a gas flow rate in cases where oxygen (O₂), atmosphere (air), and vapor (H₂O) are introduced as the oxide material and a characteristic view showing a relationship between an S (S star) and a gas flow rate in cases where atmosphere and vapor are introduced are shown, respectively, in FIGS. 5 and 6. As evident from FIGS. 5 and 6, the oxidization by the O₂ makes the holding capacity Hc lower than the vapor and the atmosphere, and the oxidization by the atmosphere brings about the S* lower than the vapor. Here, the S* is an index representing a sensitivity of magnetization reversal. As a potential of the magnetic recording medium, the higher the holding capacity Hc is, the better it is, and the lager the S* is, the better it is. In a hysteresis loop showing a relationship between a strength (H) of the external magnetic field and magnetization (M) shown in FIG. 7, a line of tangency in the Hc value is determined, and H* is determined as, H value of the external magnetic field at the cross point of the line of tangency with the line of magnetization Mr. From S*=Hc/H*, S* is determined.

From the above described two results, it is found that the vapor (H₂O) is preferably used for the formation of the oxide film of the magnetic recording medium.

The multilayer forming apparatus for forming the magnetic layer 47 from the first seed layer 42 of the magnetic recording medium by sputtering will be described below. The multilayer film forming apparatus includes a film forming chamber for fabricating a thin film of each layer. FIG. 8 is a sectional schematic diagram of the film forming chamber in the multilayer film formation apparatus of the magnetic recording medium. The film forming chamber is provided with the vapor supplying apparatus shown in FIG. 2.

The film forming chamber 23 shown in FIG. 8 includes an exhaust system 31 for exhausting the interior, a substrate holder 32 for disposing a substrate 1 at the predetermined position inside the film forming chamber 23, a plurality of cathodes 33 and 34 for generating sputtering discharges, an unillustrated sputtering power source for applying a voltage to each of the cathodes 33 and 34, and the like.

The film forming chamber 23 is an air-tight vacuum container, and is provided with an opening for taking in/out a substrate 21, and this opening is closed and opened by a gate valve 30. An exhaust system 31 is provided with a vacuum pump like a turbo-molecular pump, and carries out exhaustion through an exhaust chamber adjacent to the chamber 23.

A gas introducing system, as described above, adopts argon as a sputtering gas, and is provided with a piping 361 of argon gas. The piping 361 is provided with a flow controller 362 in addition to the valve, and can introduce the argon gas into the film forming chamber 23 through a piping 35 at a predetermined flow rate.

Each of the cathodes 33 and 34 is a cathode for realizing magnetron sputtering, that is, it is a magnetron cathode. Each of the cathodes 33 and 34 is mainly constituted by targets 331 and 341 and magnet units 332 and 342 provided at the back of the targets 331 and 341. While the magnet units 332 and 342 are not illustrated in detail, they are the magnets to realize magnetron motion of electrons by establishing an orthogonal relation between the electric field and the magnetic field, and are constituted by a central magnet, a peripheral magnet surrounding the central magnet, and the like. Further, to uniform erosion of stationary targets 331 and 341, a rotating mechanism for rotating the magnet units 332 and 342 is sometimes provided. In front of the targets 331 and 342, shutters 333 and 343 are provided. The shutters 333 and 343, when cathodes 33 and 34 thereof are not used, cover the targets 331 and 341 to prevent the contamination and the like of the targets 331 and 341.

In FIG. 8, while two cathodes 33 and 34 are illustrated, in reality, three or more number of the cathodes are sometimes provided. The structure of these cathodes can be referred to Japanese Patent Application Laid-Open No. 2002-43159.

The unillustrated sputtering power source applies a negative direct current or high frequency voltage to each of the cathodes 33 and 34, and is provided for each of the cathodes 33 and 34.

An unillustrated control unit that independently controls an input power to each of the cathodes 33 and 34 is provided.

Each layer of the magnetic recording medium shown in FIG. 4 is formed using a plurality of film forming chambers 23 of the multilayer film forming apparatus. At the terminal of the second seed layer (NiP) 43, the vapor is introduced by using the vapor supplying apparatus so as to expose the second seed layer to the vapor, thereby to oxidize the surface of the second seed layer. A water amount kept accumulated in the water supplying unit 4 is estimated by experimentally deciding the gas flow rate where Hc and S* become high from the characteristic views of FIGS. 5 and 6, and considering the operating time of the apparatus and the like based on the flow rate. The estimated water amount is kept in the vapor supplying apparatus of the multilayer forming apparatus. The temperature of the water supplying unit 4 is set based on the characteristic graph of FIG. 3 so as to become the predetermined vapor pressure, and at the oxide film formation time, the vapor is supplied from the water supplying unit.

The present invention is effective for a film formation process capable of precisely controlling a pressure of the vapor and being stabilized with good reproducibility, and can be applied to a substrate processing apparatus such as a sputtering apparatus.

1. A vapor supplying apparatus, comprising:
a holding unit for holding a liquid or solid substance;
cooling means for cooling said holding unit;
detection means for detecting the temperature of said holding unit; and
control means for controlling said cooling means based on the temperature detected by said detection means;
wherein the temperature of said holding unit is adjusted by said cooling means under the control of said control means, thereby controlling vaporization or sublimation of the liquid or solid substance for supplying a vapor of the substance.

2. The vapor supplying apparatus according to claim 1, comprising means for measuring the pressure of the vapor vaporized or sublimed from said liquid or solid under the atmosphere in which said vapor supplying apparatus is placed,
wherein said control means controls the temperature of said holding unit based on the measured pressure so that the pressure of said vapor reaches a predetermined value.

3. The vapor supplying apparatus according to claim 1, wherein said control means lowers the temperature of said holding unit to a value lower than the temperature at the vapor supplying time, for a time other than the vapor supplying time.

4. A substrate processing apparatus, comprising the vapor supplying apparatus according to claim 1.

5. The substrate processing apparatus according to claim 4, wherein said substrate processing apparatus is a film forming apparatus.

6. The substrate processing apparatus according to claim 4, wherein said holding unit of said vapor supplying apparatus is provided in a substrate processing chamber.

7. An electronic device manufacturing apparatus, comprising the vapor supplying apparatus according to claim 1.

8. The electronic device manufacturing apparatus according to claim 7, wherein said vapor supplying apparatus is used for the formation of an oxide film of an electronic device.

9. The electronic device manufacturing apparatus according to claim 8, wherein said electronic device is a tunneling magnetoresistance element, and said oxide film is a tunnel barrier layer.

10. The electronic device manufacturing apparatus according to claim 8, wherein said electronic device is a magnetic recording medium.

11. A method of manufacturing an electronic device by processing a substrate used for the electronic device in the substrate processing chamber in cooperation with a vapor supplying apparatus which comprises a holding unit for holding a liquid or solid substance, cooling means for cooling the holding unit, detection means for detecting the temperature of the holding unit, and control means for controlling said cooling means based on the temperature detected by the detection means,
wherein the temperature of said holding unit is controlled by said cooling means and said control means so that vaporization or sublimation of said liquid or solid substance is controlled in supplying the vapor into the substrate processing chamber from the vapor supplying apparatus to supply the vapor of said substance, the method comprising;
measuring the pressure of said vapor inside said substrate processing chamber, and
processing said substrate while controlling the temperature of said holding unit by said control means so that the pressure of said vapor reaches a predetermined value based on the measured pressure.

12. A method of manufacturing an electronic device by processing a substrate with used for an electronic device in a substrate processing chamber in cooperation with a vapor supplying apparatus which comprises a holding unit for holding a liquid or solid substance, cooling means for cooling the holding unit, detection means for detecting the temperature of the holding unit, and control means for controlling said cooling means based on the temperature detected by the detection means,
wherein the temperature of said holding unit is controlled by said cooling means and said control means so that vaporization or sublimation of said liquid or solid substance is controlled and the vapor is supplied into the substrate processing chamber from the vapor supplying apparatus to supply the vapor of said substance, the method comprising;
for a time other than the vapor supplying time, lowering the temperature of said holding unit to a value lower than the temperature at the vapor supplying time by said cooling means and said control means to liquefy or solidify the vapor for holding the liquid or solid substance in said holding unit, and
for the vapor supplying time, elevating the temperature of said holding unit by said cooling means and said control means to vaporize or sublimate said held liquid or solid substance for supplying the vapor of the substrate, to perform the processing of said substrate.

13. The method of manufacturing the electronic device according to claim 11, wherein said vapor is a steam, and the processing of said substrate is an oxidation processing.

14. An electronic device manufactured by the method of manufacturing the electronic device according to claim 11.

15. An electronic device comprising an oxide film formed by the method of manufacturing the electronic device according to claim 13.

16. A tunneling magnetoresistance device, wherein the electronic device according to claim 15 is a tunneling magnetoresistance device, and said oxide film is a tunnel barrier layer.

17. An electronic device, which comprises a film containing an oxide and metal particles formed by using the method of manufacturing the electronic device according to claim 13.

18. The electronic device according to claim 17, wherein the film containing said oxide and metal particles forms a granular structure.

19. The electronic device according to claim 17, wherein said electronic device is a magnetic recording medium.

20. A magnetic recording medium, wherein the electronic device according to claim 17 is a magnetic recording medium, and said film includes perpendicular magnetic anisotropy.

21. A magnetic recording medium, wherein the electronic device according to claim 17 is a magnetic recording medium, and said film is a film magnetized in the direction parallel with said substrate.

22. The electronic device according to claim 15, wherein said film is included in a magnetoresistance film operating by letting the current flow in a vertical direction with respect to a film surface.

23. A substrate processing method for processing a substrate in a substrate processing chamber in cooperation with a vapor supplying apparatus which comprises a holding unit for holding a liquid or solid substance, cooling means for cooling the holding unit, detection means for detecting the temperature of the holding unit, and control means for controlling said cooling means based on the temperature detected by the detection means,
wherein the temperature of said holding unit is controlled by using said cooling means by said control means so that vaporization or sublimation of said liquid or solid substance is controlled to supply the vapor into the substrate processing chamber from the vapor supplying apparatus to supply the vapor of said substance, the method comprising;
measuring the pressure of said vapor inside said substrate processing chamber, and
controlling the temperature of said holding unit by said control means so that the pressure of said vapor reaches a predetermined value based on the measured pressure for the processing of said substrate.

24. A substrate processing method for processing a substrate in a substrate processing chamber in cooperation with a vapor supplying apparatus which comprises a holding unit for holding a liquid or solid substance, cooling means for cooling the holding unit, detection means for detecting the temperature of the holding unit, and control means for controlling said cooling means based on the temperature detected by the detection means,
wherein the temperature of said holding unit is controlled by using said cooling means by said control means so that vaporization or sublimation of said liquid or solid substance is controlled to supply the vapor into the substrate processing chamber from the vapor supplying apparatus for supplying the vapor of said substance, the method comprises;
for a time other than the vapor supplying time, lowering the temperature of said holding unit to a value lower than the temperature at the vapor supplying time by said cooling means and said control means to liquefy or solidify the vapor to hold the liquid or solid substance in said holding unit, and
for the vapor supplying time, elevating the temperature of said holding unit by said cooling means and said control means to vaporize or sublimate said held liquid, or for supplying the vapor of the substrate.
